(19) United States
(12) Patent Application Publication
(10) Pub. No.: US 2009/0015375 A1
(43) Pub. Date: Jan. 15, 2009

(54) APPARATUS AND METHOD FOR LOCATING MISSING ARTICLE

(76) Inventor: Hyun-kap YANG, Seoul (KR)

Correspondence Address: CANTOR COLBURN, LLP, 20 Church Street, 22nd Floor, Hartford, CT, 06103, US

(21) Appl. No.: 11/960,213

(22) Filed: Dec. 19, 2007

(30) Foreign Application Priority Data
Jul. 9, 2007 (KR) 10-2007-0068766

(51) Int. Cl. H04Q 7/00

(52) U.S. Cl. 340/7.2

(57) ABSTRACT

Disclosed herein are an apparatus for locating a missing article, which senses and responds to only a wave-shaped sound composed of long-period signals generated by the user and a silent time between the long-period signals, and a method for locating a missing article using the same. The apparatus includes a signal sensor for sensing a wave-shaped signal, a signal processor for interrupting an input of the sensed signal when the sensed signal is maintained for less than a predetermined time, and compulsorily interrupting an output of the sensed signal when the sensed signal is maintained for more than the predetermined time, and a main controller for comparing an Output signal from the signal processor with a password stored in a memory, and outputting control signals for generation of visual and audible location confirm signals when the output signal from the signal processor is the same as the stored password.

### BACKGROUND OF THE INVENTION

1. Field of the Invention

The present invention relates to an apparatus and method for locating a missing article, and more particularly to an apparatus for locating a missing article, which senses and responds to only a wave-shaped sound composed of long-period signals generated by the user and a silent time between the long-period signals, and a method for locating a missing article using the same.

2. Description of the Related Art

In general, a home appliance used in a home, such as a television (TV), is manufactured in such a manner that a remote controller (hereinafter, abbreviated to a “remocon”) is used for the home appliance to provide convenience to the user. The use of the remocon increases convenience in product use. However, the user may forget the remocon's location after the use of the remocon due to his/her carelessness or forgetfulness. Further, in the case where all members of the user's family use the remocon, they may place the remocon at different locations after using the remocon. In these cases, much effort and time are often wasted to find the remocon. As a result, the user has the inconvenience of having to move to the home appliance and personally operate a switch of the home appliance.

Moreover, there is a high risk that mobile phones, key rings, purses, handbags, bags, etc. essentially used by general persons may be lost. In particular, because the purse is so small that an owner thereof may not know where the purse is kept, the owner must often search for the purse. In addition, provided that an owner of a car does not pre-memorize the location of his/her car in a large parking place where many cars are parked, he/she will later search for his/her car with much inconvenience. Therefore, various technologies for locating missing articles have been proposed to solve inconvenience resulting from time and effort required to find the corresponding articles.

One such conventional technology is disclosed in U.S. Pat. No. 9,507,653 (ELECTRONIC SOUND DETECTING UNIT FOR LOCATING MISSING ARTICLES). This conventional technology is desirable in that a separate transmitter is unnecessary owing to the use of human-generated sounds, but has a disadvantage in that a signal processor responds sensitively to all external noises without distinction between a short-period signal having a short duration and a long-period signal having a long duration, thereby causing a faulty operation to occur frequently, resulting in a large amount of battery consumption. Particularly, in order to remove contact noise generated by physical contact with the missing article locating unit, among the external noises, a separate contact/vibration noise removing device is required, thus making the configuration of the unit complicated and increasing the manufacturing cost of the unit, leading to poor economy of the unit.

### SUMMARY OF THE INVENTION

Therefore, the present invention has been made in view of the above problems, and it is an object of the present invention to provide an apparatus for locating a missing article, which senses and responds to only a wave-shaped sound composed of long-period signals generated by the user and a silent time between the long-period signals, and a method for locating a missing article using the same. Sounds existing in the natural world are mainly composed of short-period signals having durations of less than 0.1 or 0.2 seconds. In this connection, the present invention provides an apparatus for locating a missing article, which does not respond to general external noises composed of short-period signals, with the exception of a wave-shaped sound generated by the user, which is composed of high-level long-period signals having durations of 0.1 or 0.2 seconds or more generated by the user and a silent time set between the long-period signals. Therefore, the missing article locating apparatus according to the present invention does not respond to general external noises in the natural world.

It is another object of the present invention to provide an apparatus for locating a missing article, which is driven with only standby current in a standby mode to minimize battery consumption thereof and is woken up by recognizing a long-period wake-up signal distinguishably from noises of short-period signals, such as ambient noise or contact noise, when the long-period wake-up signal is inputted thereto, thereby preventing battery current from being excessively consumed due to unnecessary wake-up of the missing article locating apparatus, and a method for locating a missing article using the same.

It is a further object of the present invention to provide an apparatus and method for locating a missing article, in which a relatively short-period signal, as well as a long-period signal, can be inputted as finding signals after a wake-up signal is inputted, so that valid signals having various durations can be used as the finding signals.

It is a further object of the present invention to provide an apparatus and method for locating a missing article, in which a signal processor compulsorily interrupts a signal inputted continuously for more than a predetermined effective time so that the missing article locating apparatus can maintain a standby current state while the signal lasts, thereby reducing unnecessary current consumption resulting from continuous repetitive ON/OFF operations of the missing article locating apparatus due to external continuous noises.

It is another object of the present invention to provide an apparatus and method for locating a missing article, in which, even though the missing article locating apparatus visually and audibly responds to an unintended wave-shaped sound, the operation of the missing article locating apparatus is stopped automatically when successive noises are continuously generated, or manually by a function switch.

It is yet another object of the present invention to provide an apparatus and method for locating a missing article, in which silent times are set respectively between a wake-up signal and a finding signal, between respective finding signals including the finding signal when the number of the finding signals is set to two or more, and after a last one of the finding signals, so that there can be a difference between Ambient repetitive noises and wave-shaped signals set by the user, thereby preventing a faulty operation of the missing article locating apparatus.

In accordance with an aspect of the present invention, the above and other objects can be accomplished by the provision of an apparatus for locating a missing article, comprising: a signal sensor for sensing a wave-shaped signal generated by a user; a signal processor for interrupting an input of the wave-shaped signal sensed by the signal sensor when the sensed signal is maintained for less than a predetermined time, and compulsorily interrupting an output of the sensed signal when the sensed signal is maintained for more than the predetermined time; a main controller for comparing an output signal from the signal processor with a password stored in a memory, and outputting control signals for generation of visual and audible location confirm signals when the output signal from the signal processor is the same as the stored password; an indicator for generating the visual location confirm signal in response to a corresponding one of the control signals from the main controller; and a tone generator for generating the audible location confirm signal in response to a corresponding one of the control signals from the main controller.

The wave-shaped signal may include any one of a wake-up signal which is a long-period signal of a certain length and a finding signal which is a long-period signal of the certain length or a relatively short-period signal. Silent times and finding password wait times may be set respectively between he wake-up signal and the finding signal, between respective finding signals including the finding signal when the number of tire finding signals is set to two or more, and after a last one of the finding signals.

The main controller may determine the wake-up signal to be valid when the wake-up signal passes a wake-up hardware delay time determined by a circuit configuration, wakes up the main controller and lasts up to a wake-up program delay time determined by a program of the main controller.

The finding password wait times may include a first finding password wait time set after a first one of the silent times following the wake-up signal, and the main controller may determine the finding signal to be valid when the finding signal is inputted for the first finding password wait time, passes a finding hardware delay time determined by a circuit configuration and lasts up to a finding program delay time determined by a program of the main controller. The silent times may include a last silent time set after the last finding signal, and the last silent time may be set to be longer than the respective silent times set between the respective finding signals.

In accordance with another aspect of the present invention, there is provided an apparatus for locating a missing article, comprising: a signal sensor including a piezoelectric element for detecting an external signal and generating a location confirm sound, a signal buffer for buffering the signal detected by the piezoelectric element, and an analog/digital converter for converting an analog signal from the signal buffer to a digital signal; a signal processor including an integrator for integrating a signal sensed by the signal sensor, a signal delay for delaying an output signal from the integrator, an inverter for interrupting an output signal from the signal delay when it is inputted for less than a predetermined time and inverting a phase of the output signal from the signal delay when it is inputted for the predetermined time or more, and a compulsory signal interrupter for compulsorily interrupting an output signal from the inverter when the output signal from the inverter lasts for more than the predetermined time; and a main controller including a memory for storing a password, and a plurality of timers for counting respective periods of a wake-up signal and one or more finding signals, silent times, and one or more finding password wait times, respectively.

In accordance with a further aspect of the present invention, there is provided a method for locating a missing article using a missing article locating apparatus, comprising: a) if an input signal lasts for a wake-up hardware delay time determined by a circuit configuration of the missing article locating apparatus in a standby mode where standby power is supplied to the apparatus, calling a wake-up password processing routine and supplying main power to the apparatus, and if the input signal further lasts for a wake-up program delay time, determining the input signal to be a valid wake-up signal, determining whether a signal is inputted for a first silent time, and starting time counting for confirmation of a finding signal if no signal is inputted for the first silent time; b) calling a finding password processing routine if the finding signal is inputted at a predetermined timing during the time counting at the step a), determining whether a signal is inputted for a second silent time if a pre-registered finding password is set to two or more, and determining whether the pre-registered finding password is satisfied if no signal is inputted for the second silent time; and c) determining whether a signal is inputted for a last silent time if the pre-registered finding password is satisfied, calling a location confirm sound generating routine to generate a location confirm sound, if no signal is inputted for the last silent time, and stopping the generation of the location confirm sound if a signal is sensed in the middle of generating the location confirm sound, a signal is inputted through a function input unit, or the number of times that the location confirm sound is generated expires.

In accordance with yet another aspect of the present invention, there is provided an input method of a function input unit of a missing article locating apparatus, comprising: a) if a function key of the function input unit is operated in a standby mode where standby power is supplied to the missing article locating apparatus, supplying main power to the apparatus and determining whether the function key has been pressed for a predetermined first time or more, and if it is determined that the function key has not been pressed for the first time or more, recognizing the pressing of the function key as an abnormal key operation, initializing each port and then turning the main power off; b) if the function key has been pressed for the first time or more, recognizing the pressing of the function key as a normal key operation, generating a beep and flickering a light emitting diode, so as to inform a user that the function key has normally been operated; c) determining whether the function key has been pressed for a predetermined second time or more after the step b), and if it is determined that the function key has not been pressed for the second time or more, recognizing that the user uses the missing article locating apparatus as an illuminator and turning the light emitting diode on to perform an illumination function; d) if the function key is again inputted or a certain time elapses after the light emitting diode is turned on, turning the light emitting diode off to end the illumination function, initializing each port and then turning the main power off; and e) if it is determined at the step c) that the function key has been pressed for the second time or more, generating the beep and flickering the light emitting diode, so as to inform the user that he/she has to set a finding password, and calling a finding password input routine to set the finding password.

According to the present invention, there is provided a missing article locating apparatus which is capable of allowing the user to easily find a desired object.

The missing article locating apparatus can accurately perform a missing article locating function by sensing a wave-shaped sound composed of long-period signals generated by the user using a whistle or similar tool, and a silent time between the long-period signals.

Further, the missing article locating apparatus can recognize a wave-shaped signal distinguishably from various noises such as ambient noise or contact noise, so as to prevent a faulty operation resulting from the various noises.

Further, the missing article locating apparatus can be prevented from being changed from a standby current state with small current consumption to an operating current state with large current consumption by responding, one by one, to innumerable short-period signals generated due to ambient noises. Therefore, it is possible to minimize current consumption of the missing article locating apparatus and radically preventing a faulty operation of the apparatus.

Further, in order to prevent unnecessary current consumption and a faulty operation of the missing article locating apparatus, only a long-period signal can be inputted and recognized as a wake-up signal. However, a relatively short-period signal, as well as a long-period signal, can be inputted as finding signals after the wake-up signal is inputted, so that valid signals having various durations can be used as the finding signals.

Moreover, a signal processor can compulsorily interrupt a signal inputted continuously for more than a predetermined effective time so that the missing article locating apparatus can maintain a standby current state while the signal lasts, thereby making it possible to reduce unnecessary current consumption resulting from continuous repetitive ON/OFF operations of the missing article locating apparatus due to external continuous noises.

Moreover, even though the missing article locating apparatus visually and audibly initiates its output in response to an unintended wave-shaped sound, the operation of the missing article locating apparatus can be stopped automatically when successive noises are continuously generated, or manually by a function switch of a function input unit. In addition, when the operation of the missing article locating apparatus is not stopped automatically because successive noises are not continuously generated, the user may generate a signal recognizable by the apparatus by a whistle or physical contact with the apparatus to immediately stop the output of the apparatus, without operating the function input unit.

Furthermore, silent times can be set respectively between a wake-up signal and a finding signal, between respective finding signals including the finding signal when the number of the finding signals is set to two or more, and after a last one of the finding signals. Therefore, there can be a difference between ambient repetitive noises and wave-shaped signals, thereby preventing a faulty operation of the missing article locating apparatus.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of an embodiment of a missing article locating apparatus according to the present invention;

FIG. 2 is a circuit diagram of the missing article locating apparatus of FIG. 1;

FIG. 3A is an input/output timing diagram of a wave-shaped signal;

FIG. 3B is an input/output timing diagram of a noise signal;

FIG. 4 is a timing diagram for password recognition according to the present invention;

FIG. 5 is a circuit diagram of a different embodiment of a tone generator in FIG. 1;

FIG. 6 is a flowchart illustrating an embodiment of an input process of a function input unit according to the present invention;

FIG. 7 is a flowchart illustrating an embodiment of a finding password input routine in FIG. 6;

FIG. 8 is a flowchart illustrating an embodiment of a wake-up signal processing process of a missing article locating method according to the present invention;

FIG. 9 is a flowchart illustrating an embodiment of a finding password processing routine in FIG. 8; and

FIG. 10 is a flowchart illustrating an embodiment of a location confirm sound generating routine in FIG. 9.

### DETAILED DESCRIPTION OF THE PREFERRED EMBODIMENTS

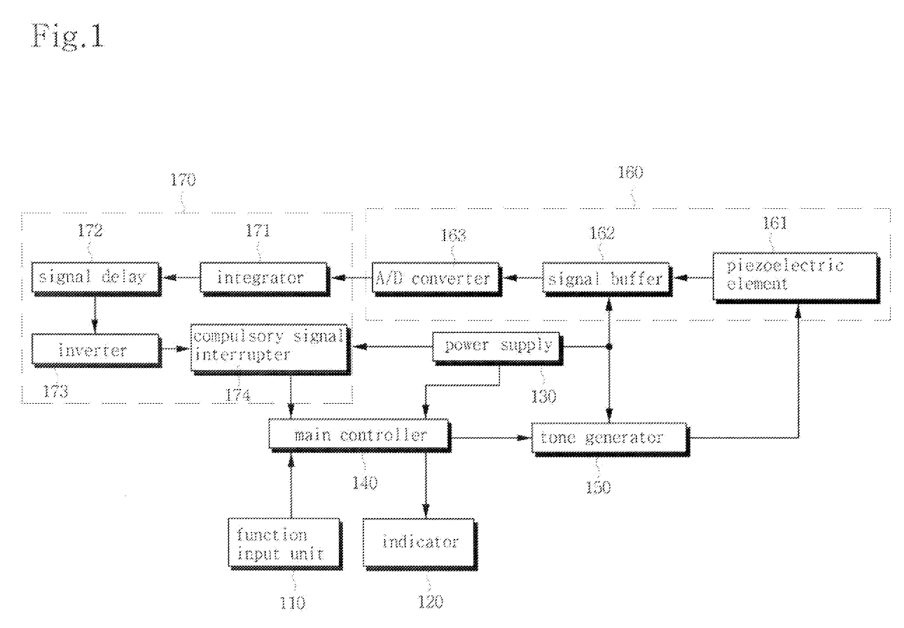

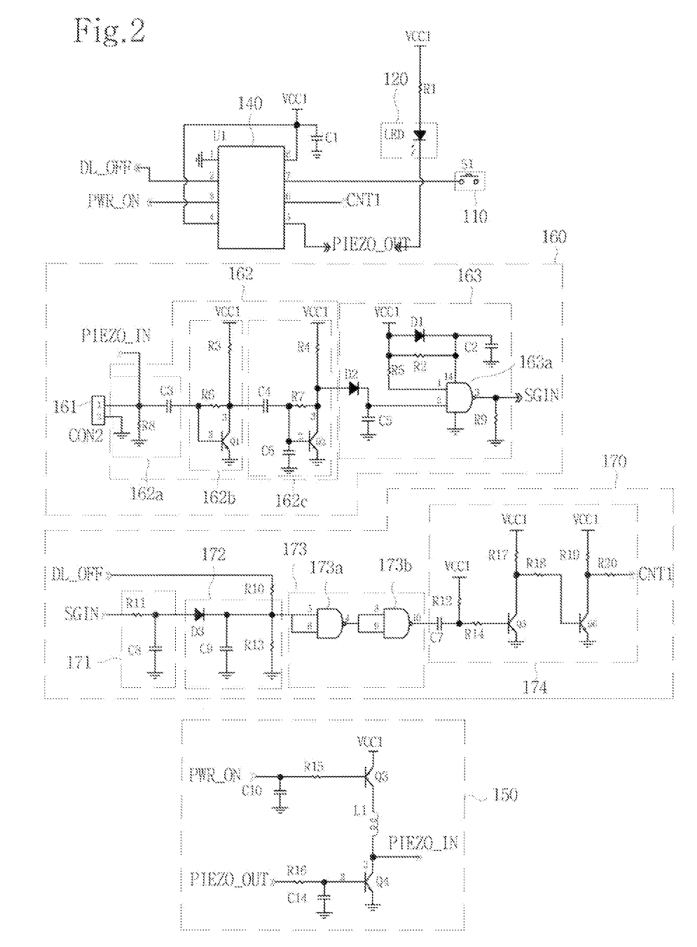

FIG. 1 is a block diagram showing the configuration of an embodiment of a missing article locating apparatus according to the present invention, and FIG. 2 is a circuit diagram of the missing article locating apparatus of FIG. 1.

In FIG. 1, a function input unit 110 includes one or more function switches for setting and changing a password, using a lamp function, and stopping generation of a location confirm sound. Preferably, the function input unit 110 is composed of a single function switch for changing functions according to time periods and points that it is pressed, or setting a password according to the number of times that it is pressed.

A main controller 140 acts to, when a wake-up password and a finding password are inputted through the function input unit 110, store the inputted passwords in a memory of the main controller 140.

An indicator 120 provides a visual indication for confirmation of a key input when a function such as password setting is performed, or is used as an illumination lamp. Also, when a wave-shaped signal is inputted, the indicator 120 is illuminated with a drive signal from the main controller 140 to generate a visual location confirm signal. Preferably, tho indicator 120 is implemented with a light emitting diode (LED).

A power supply 130 selectively supplies standby power in a standby mode and main power in a wake-up mode.

A signal sensor 160 includes a piezoelectric element 161 for detecting an external signal and generating a location confirm sound, a signal buffer 162 for buffering the signal detected by the piezoelectric element 161, and an analog/digital (A/D) converter 163 for converting an analog signal from the signal buffer 162 to a digital signal.

A signal processor 170 includes an integrator 171 for integrating a signal sensed by the signal sensor 160, a signal delay 172 for delaying an output signal from the integrator 171, an inverter 173 for interrupting an output signal from the signal delay 172 when it is inputted for less than a predetermined time and inverting the phase of the output signal from the signal delay 172 when it is inputted for the predetermined time or more, and a compulsory signal interrupter 174 for providing an output signal from the inverter 173 to the main controller 140 and compulsorily interrupting the provision of the output signal from the inverter 173 to the main controller 140 when the output signal from the inverter 173 is maintained for more than the predetermined time. This signal processor 170 functions to remove noise of the signal sensed by the signal sensor 160 and output only a wave-shaped signal generated by the user. To this end, the signal processor 170 interrupts the input of the sensed signal when the sensed signal is maintained for less than the predetermined time, and compulsorily interrupts the output of the sensed signal to the main controller 140 when the sensed signal is maintained for more than the predetermined time.

Preferably, the main controller 140 includes a memory for storing wake-up and finding passwords, a timer for counting respective periods of a wake-up signal and a finding signal, a timer for counting a first silent time ST1 between the wake-up signal and the finding signal, a second silent time ST2 between respective finding signals including the finding signal when the finding password is set to two or more, and a last silent time ST3 between a last one of the finding signals and the location confirm sound, and a timer for counting a finding password wait time. The main controller 140 compares a signal normally outputted from the signal processor 170 with the passwords stored in the memory and outputs control signals for generation of visual and audible location confirm signals when the normally outputted signal is determined to be a locating signal generated by the user as a result of the comparison. The main controller 140 is preferably implemented with a microprocessor or micro controller unit (MCU).

A tone generator 150 generates the audible location confirm signal to the piezoelectric element 161 of the signal sensor 160 in response to the corresponding control signal from the main controller 140. The piezoelectric element 161 generates the location confirm sound in response to the location confirm signal from the tone generator 150, or acts as a receiver for sensing a received sound when it does not generate the location confirm sound.

In the present invention, the wave-shaped signal is any one of a wake-up signal which is a long-period signal of a certain length and a finding signal which is a long-period signal of the certain length or a relatively short-period signal based on the user's setting. Silent times and finding password wait times are set respectively between the wake-up signal and the finding signal, between respective finding signals including the finding signal when the number of the finding signals is set to two or more, and between a last one of the finding signals and the location confirm sound. The number of wake-up signals including the wake-up signal and the number of the finding signals are fixed by a program or may be set or changed by the user.

A description will hereinafter be given of the operation of the missing article locating apparatus with the above-stated configuration according to the present invention.

In the present invention, the wake-up password means the number of wake-up signals for waking up the missing article locating apparatus, and the finding password means the number of finding signals for calling the missing article locating apparatus subsequently to the wake-up signals. Although a number of ‘1’ or more may be inputted as the wake-up password WP, the wake-up password WP is fixed at ‘1’ in the present invention. The finding password FP can also be set or changed by the user. In the present invention, the finding password FP can be variously selected or changed within the range of 1 to n. Here, the main controller 140 is woken up in response to a wave-shaped long-period signal (wake-up signal) which is inputted as the wake-up password under the condition that the main power of the missing article locating apparatus is turned off for power saving. Because the wake-up password is fixed at ‘1’ in the present embodiment, a description of an example of setting or changing the wake-up password in a separate way will be omitted. The user can set or change the finding password by operating a function switch S1 of the function input unit 110. When the user sets or changes the finding password by inputting it through the function switch S1 of the function input unit 110, the main controller 140 stores the inputted, set or changed finding password in the memory thereof.

Under the condition that the wake-up password and the finding password are set in the above manner, the circuitry of the signal sensor 160 is driven with the standby power supplied from the power supply 130 in the standby mode so that current consumption of a battery contained in the missing article locating apparatus can be minimized. That is, in order to find the missing article locating apparatus in the standby mode where only the standby power is supplied to the apparatus, the user has to generate long-period signals which correspond to the set passwords and have the same duration as that defined by the circuitry and program, using a whistle or similar tool.

In general, most sounds existing in the natural world are mainly composed of short-period signals having durations of less than 0.1 or 0.2 seconds. However, in the case of using a sound generated using a person's mouth or fingers, a whistle, a copper coin or other tools, everybody can easily generate high-level long-period signals having durations of 0.1 or 0.2 seconds or more. In this connection, in the present invention, the long-period signal means a high-level continuous sound signal having the duration of 0.1 or 0.2 seconds or more which is distinguished from general short-period signals existing in the natural world. It will be understood here that the long-period signal is described for illustrative purposes to have the duration of 0.1 or 0.2 seconds or more and the duration of the long-period signal can be changed as needed. In the present invention, the short-period signal means a signal having a shorter duration than that of the long-period signal.

If a long-period signal is generated, it is received by the signal sensor 160. That is, as shown in FIG. 2, the long-period signal is received by the piezoelectric element 161, buffered by the signal buffer 162 and then transferred to the A/D converter 163. In the signal buffer 162, a band pass filter 162a, which includes a capacitor C3 and a resistor R8, fitters the signal received by the piezoelectric element 161 to output only a signal of a predetermined band. The output signal from the band pass filter 162a is primarily amplified by a primary amplifier 162b including an amplifying transistor Q1, and secondarily amplified by a secondary amplifier 162c including a sensitivity adjusting capacitor C4 and an amplifying transistor Q2. The resulting signal amplified in this manner is converted to a digital signal through a NAND gate 163a of the A/D converter 163 and then provided to the signal processor 170.

In the signal processor 170, the output signal from the A/D converter 163 is integrated by the integrator 171, which includes a resistor R11 and a capacitor C8. The integrated signal is passed through a diode D3 of the signal delay 172 and then delayed by a capacitor C9 and resistor R13 of the signal delay 172. The delayed signal is inverted in phase through first and second NAND gates 173a and 173b and then transferred to the compulsory signal interrupter 174. In the compulsory signal interrupter 174, the turning-on and turning-off of a switching element Q5 are determined depending on a time constant of a capacitor C7 and resistor R12 and the transferred signal (wave-shaped signal), and a switching operation of a switching element Q6 is performed based on the turning-on and turning-off of the switching element Q5. The switching element Q6 is operated to transfer or compulsorily interrupt the wave-shaped signal (sensed signal) to the main controller 140. That is, when a wave-shaped, sensed signal is inputted, the compulsory signal interrupter 174 transfers the wave-shaped, sensed signal to the main controller 140 for only a predetermined time based on the time constant, and compulsorily interrupts the wave-shaped, sensed signal to the main controller 140 when the wave-shaped, sensed signal is maintained for more than the predetermined time. In other words, in the case where a long-period signal similar to a wave-shaped signal is generated due to ambient noise and inputted to the missing article locating apparatus, the main controller 140, when the long-period signal is not the same as the wave-shaped signal, determines the long-period signal to be a noise signal and automatically powers the missing article locating apparatus off. In this case, however, while the external noise is continuously generated, the missing article locating apparatus is repeatedly powered on and off, resulting in unnecessary current consumption of the battery. For this reason, when the external noise is continuously generated for more than the predetermined time, the main controller 140 does not interrupt the input signal thereto in a software manner and the compulsory signal interrupter 174 compulsorily interrupts the sensed signal to the main controller 140 to reduce unnecessary current consumption of the battery.

That is, the signal processor 170 distinguishes the signal sensed by the signal sensor 160 between a noise signal and a wave-shaped signal, and removes the sensed signal when it is the noise signal and finally outputs the sensed signal as a signal CNT1 to the main controller 140 when it is the wave-shaped signal. In the case where the wave-shaped signal lasts for more than a time set by the circuitry and program, the signal processor 170 automatically interrupts the signal CNT1 which is the sensed signal provided to the main controller 140. The distinction between the noise signal and the wave-shaped signal is made in the following manner. First, whether to filter the sensed signal is determined based on a time constant of the capacitor C8 and resistor R11. Then, the signal passed through the diode D3 is delayed by a delay time based on a time constant of the capacitor C9 and resistor R13. Here, a hardware delay time is determined based on the time constants of the constituent elements of the integrator 171 and signal delay 172. Provided that the input signal is such a short-period signal that the duration thereof does not exceed the hardware delay time, it is not outputted to the downstream circuit configuration. In conclusion, the integrator 171 and signal delay 172 act as a filter for a short-period signal having a short duration, so as to make a distinction between the noise signal and the wave-shaped long-period signal.

The finally outputted wave-shaped signal is inverted by the NAND gates 173a and 173b. At this time, the delay time of the signal delay 172 can be reduced by a delay off signal DL-OFF generated by the main controller 140. That is, the main controller 140 generates the delay off signal DL-OFF subsequently to a wake-up signal to partially shorten a hardware delay time WHDT for the wake-up signal so as to apply the resulting hardware delay time as a hardware delay time FHDT for a finding signal. As a result, the hardware delay time FHDT for the finding signal is shorter than the hardware delay time WHDT for the wake-up signal. Consequently, the finding signal can be recognized as a valid signal even though it has a duration shorter than that of the wake-up signal. Alternatively, without generating the delay off signal DL-OFF, the same hardware delay time FHDT as the hardware delay time WHDT for the wake-up signal may also be applied to the finding signal. Therefore, the user may generate valid signals having various durations, such as a short duration or long duration, as the finding signal.

Next, the location confirm sound is generated in the following manner. In the tone generator 150, a transistor Q3 is turned on in response to a power-on signal PWR-ON from the main controller 140 to supply a voltage for generation of an intermittent sound through a coil L1. At this time, if an intermittent sound signal PIEZO-OUT from the main controller 140 is inputted, a transistor Q4 is turned on to allow current to flow therethrough. The amount of current per pulse is inversely proportional to the inductance of the coil. When the current through the coil is intermitted by a square wave, a considerably high counter-electromotive voltage is generated to drive the piezoelectric element 161. In the present embodiment, the counter-electromotive voltage is 15V at maximum with respect to a voltage VCC1 of 3V.

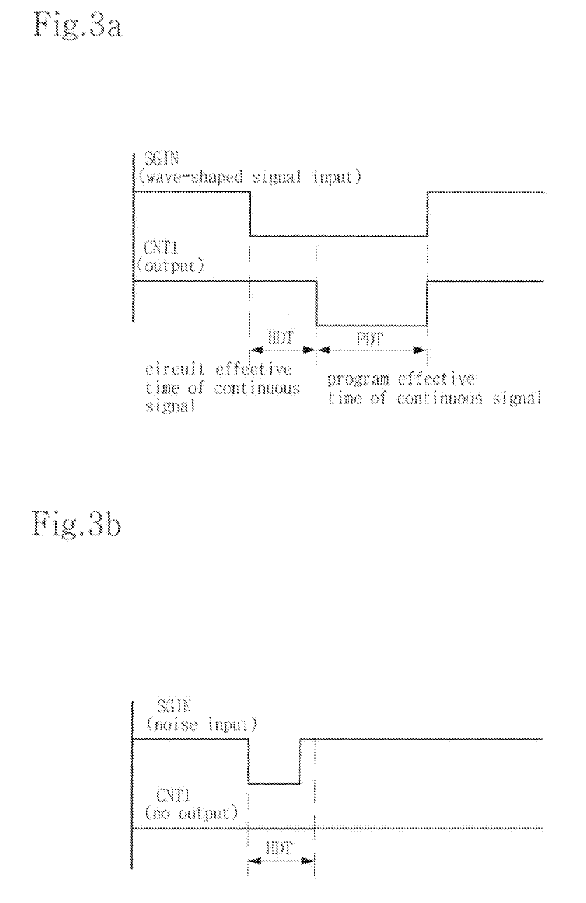

FIG. 3A an input/output timing diagram of a wave-shaped signal, and FIG. 3B is an input/output timing diagram of a noise signal. As shown, an input signal is passed only when it has a predetermined duration. Otherwise, the input signal is filtered, and thus not passed. That is, whether to filter the input signal is determined depending on the time constants of the constituent elements of the integrator 171 and signal delay 172. By adjusting these time constants, a distinction can be made between noise composed of a short-period signal having a duration of, for example, less than 0.1 or 0.2 seconds and a long-period signal having a duration of, for example, 0.1 or 0.2 seconds or more. As a result, the missing article locating apparatus does not respond, one by one, to innumerable short-period signals generated due to ambient noises and is powered on in response to only a wave-shaped long-period signal having a duration of a predetermined time or more, so as to minimize the current consumption of the battery. In conclusion, a hardware delay time HDT is generated based on the above time constants and then operatively associated with a program delay time (PDT) which is a program effective time.

The main controller 140 receives the signal provided from the signal processor 170 as a wave-shaped signal and compares the duration of the received signal with the duration of a wake-up signal defined in the program to determine whether to perform the next operation of the missing article locating apparatus. In the case where the wave-shaped signal is determined to be a normal wake-up signal, the main controller 140 drives the missing article locating apparatus, and receives and authenticates a finding password. For the finding password authentication, the main controller 140 compares the number of finding signals with the finding password stored in the memory thereof. In the case where the number of finding signals is not the same as the stored finding password, the main controller 140 returns to the standby mode. Conversely, in the case where the number of finding signals is the same as the stored finding password, the main controller 140 recognizes that the user is looking for the missing article locating apparatus, and thus generates drive signals to the indicator 120 and tone generator 150, respectively.

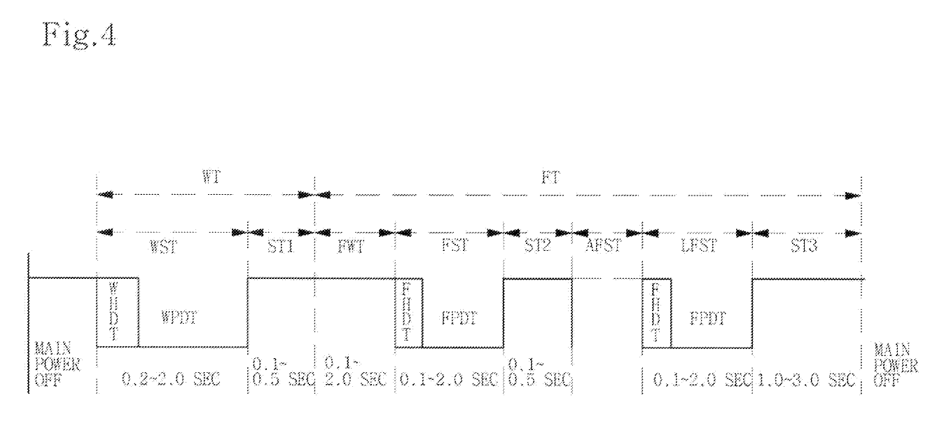

FIG. 4 is a timing diagram for password recognition according to the present invention. The missing article locating apparatus according to the present invention can make an accurate distinction between a wave-shaped signal and an irregular noise signal on the basis of the timing diagram of FIG. 4.

A wake-up time WT is the sum of a wake-up signal time WST and a first silent time ST1. The wake-up signal time WST is a time for determination as to whether a wake-up signal is valid, which consists of a wake-up hardware delay time WHDT determined by a circuit configuration and a wake-up program delay time WPDT determined by a program of the main controller 140.

For example, the setting of the wake-up signal time WST to 0.2 to 2 seconds means that all wake-up signals having durations of 0.2 to 2 seconds are valid. Notably, even though the user recognizes that he/she must make a sound continuously for a lengthy period of time, he/she will make long-period sounds having various durations due to his/her different subjective determinations at different time points. In this connection, the time interval of the wake-up signal time WST allows the missing article locating apparatus to recognize long-period sounds having various durations made by the user as valid signals as far as possible, thereby increasing the recognition rate of the missing article locating apparatus.

The first silent time ST1 is a silent time for determination as to whether a wake-up signal is valid after generation of the wake-up signal, which may be set to, for example, 0.1 to 0.5 seconds. This silent time is an essential time interval between, for example, two sound signals generated by the user, namely, one wake-up signal and one finding signal. If a new signal is inputted within the silent time, the missing article locating apparatus is powered off.

In other words, for example, assume that the wake-up hardware delay time WHDT is set to 0.3 seconds by the circuit configuration, the wake-up program delay time WPDT is set to 0.1 to 1.7 seconds by the program, the wake-up signal time WST is set to 0.4 to 2 seconds, the sum of the wake-up hardware delay time WHDT and the wake-up program delay time WPDT, and the first silent time ST1 is set to 0.3 seconds. When a sensed signal lasts for 0.3 seconds or more, the missing article locating apparatus is switched from standby current (power-off current) to operating current (power-on current) and the main controller 140 is woken up to measure a program delay time of the sensed signal. If the sensed signal lasts for 0.1 to 1.7 seconds after passing the wake-up hardware delay time WHDT, 0.3 seconds, the main controller 140 recognizes that the sensed signal is a valid wake-up signal. If the sensed signal has a duration of less than the wake-up hardware delay time WHDT, 0.3 seconds, the missing article locating apparatus stays in the power-off state (standby mode). If the sensed signal has a duration of 0.3 seconds or more and less than 0.4 seconds, it satisfies the wake-up hardware delay time WHDT, but does not satisfy the wake-up program delay time WPDT. As a result, the missing article locating apparatus is powered on at 0.3 seconds and then powered off again. If the duration of the sensed signal exceeds the wake-up signal time WST, 2 seconds, it conflicts with the first silent time ST1. As a result, the main controller 140 recognizes that the sensed signal is an invalid wake-up signal, and switches the missing article locating apparatus from the power-on state to the power-off state at the moment that the sensed signal is ended. At this time, if the sensed signal lasts for more than a time set in the compulsory signal interrupter 174 before it is ended, the main controller 140 compulsorily changes the missing article locating apparatus to the power-off state even though the sensed signal continues. On the other hand, in the case where the duration of the sensed signal is satisfied within the wake-lap signal time WST, the main controller 140 proceeds to the next stage, the first silent time ST1. At this stage, if an additional signal is inputted within 0.3 seconds, the main controller 140 immediately changes the missing article locating apparatus to the power-off state. If no additional signal is inputted for 0.3 seconds, the main controller 140 proceeds to the next stage, a finding password wait time FWT.

The finding password wait time FWT is a wait time until a finding signal is inputted after the wake-up time WT passes. Assuming that the finding password wait time FWT is set to 2 seconds, it means that a finding signal must be inputted within 2 seconds. The finding password wait time FWT is provided to increase the recognition rate of the missing article locating apparatus in consideration of a difference among time points that various users initiate the input of a finding signal after the wake-up time WT passes. If a finding signal is inputted within 2 seconds after the first silent time ST1, the main controller 140 proceeds to the next stage, a finding signal time EST. If no finding signal is inputted until 2 seconds elapse after the first silent time ST1, the main controller 140 immediately changes the missing article locating apparatus to the power-off state even though a wake-up signal was properly inputted.

The finding signal time FST is a time for determination as to whether a finding signal is valid, which consists of a finding hardware delay time FHDT determined by the circuit configuration and a finding program delay time FPDT determined by the program of the main controller 140. For example, the setting of the finding signal time FST to 0.1 to 2 seconds means that all finding signals having durations of 0.1 to 2 seconds are valid. Notably, even though the user recognizes that he/she must make a sound continuously for a lengthy period of time, he/she will make long-period sounds having various durations due to his/her different subjective determinations at different time points. In this connection, the time interval of the finding signal time EST allows the missing article locating apparatus to recognize long-period sounds having various durations made by the user as valid signals as far as possible, thereby increasing the recognition rate of the missing article locating apparatus.

The second silent time ST2 is a silent time for, when two or more finding signals are set by the user, determining whether each finding signal is valid, which may be set to, for example, 0.1 to 0.5 seconds. This silent time is an essential time interval between two finding signals until the second finding signal is inputted after the first finding signal is inputted, when the finding password is set to ‘2’ by the user. If an external signal is inputted within this silent time, the missing article locating apparatus is immediately powered off.

In other words, for example, assume that the finding hardware delay time FHDT is set to 0.2 seconds by the circuit configuration, the finding program delay time FPDT is set to 0.2 to 1.8 seconds by the program, the finding signal time FST is set to 0.4 to 2 seconds, the sum of the finding hardware delay time FHDT and the finding program delay time FPDT, and the second silent time ST2 is set to 0.2 seconds. When a sensed finding signal lasts for 0.2 seconds, the main controller 140 determines whether the sensed finding signal then satisfies the finding program delay time FPDT, because the sensed finding signal has satisfied the finding hardware delay time FHDT. If the sensed finding signal lasts for 0.2 to 1.8 seconds after passing the finding hardware delay time FHDT, 0.2 seconds, the main controller 140 recognizes that the sensed finding signal is valid. That is, if the sensed finding signal has a duration of the finding signal time FST, 0.4 to 2 seconds, the main controller 140 recognizes that the sensed finding signal is valid. If the sensed finding signal has a duration of less than the finding hardware delay time FHDT, 0.2 seconds, the main controller 140 recognizes that the sensed finding signal does not satisfy the finding hardware delay time FHDT and, in turn, the finding program delay time FPDT. As a result, the main controller 140 waits for the finding password wait time FWT set at the stage prior to the finding signal time FST and then changes the missing article locating apparatus to the power-off state. If the sensed finding signal has a duration of 0.2 seconds or more and less than 0.4 seconds, it satisfies the finding hardware delay time FHDT, but does not satisfy the finding program delay time FPDT. As a result, the missing article locating apparatus is switched to the power-off state. If the duration of the sensed finding signal exceeds the finding signal time FST, 2 seconds, the main controller 140 recognizes that the sensed finding signal is an invalid finding signal, and switches the missing article locating apparatus from the power-on state to the power-off state at the moment that the sensed finding signal is ended. At this time, similarly to a wake-up signal, if the sensed finding signal lasts for more than a time set in the compulsory signal interrupter 174 before it is ended, the main controller 140 compulsorily changes the missing article locating apparatus to the power-off state even though the sensed finding signal continues. That is, the compulsory signal interrupter 174 performs the same function with respect to respective input signals.

The subsequent stage is different depending on the number of finding signals set by the user. For example, in the case where the number of finding signals set by the user is one, namely, the finding password is set to ‘1’ by the user, the main controller 140 proceeds directly from the stage of the finding signal time FS1 to the stage of a last silent time ST3 longer than the second silent time ST2. In the case where the number of finding signals set by the user is two or more, namely, the finding password is set to ‘2’ or more by the user, the main controller 140 proceeds from the stage of the finding signal time FST to the stage of the second silent time ST2. That is, if a signal is inputted within the second silent time ST2, 0.2 seconds, after the first finding signal time FST stage, the main controller 140 immediately changes the missing article locating apparatus to the power-off state. However, if no signal is inputted for 0.2 seconds, the main controller 140 waits for a next finding signal.

An additional finding signal time AFST is applied only in the case where two or more finding signals are set by the user. After the second silent time ST2 passes subsequently to the input of the first finding signal at the previous stage, the main controller 140 performs the stages of second, third, fourth, . . . , nth finding signal times arbitrarily set by the user. At this time, the second silent time ST2 is present between respective finding signals. It should be noted here that the effective times of the respective finding signals do not need to be equal and the respective silent times ST2 do not need to be equal, but the last silent time ST3 must be set to be longer than the preceding silent time ST2. For example, in the case where two finding signals are set by the user, after performing the stages of the wake-up signal time WST, first silent time ST1, first finding password wait time FWT, first finding signal time FST, second silent time ST2 and second finding password wait time FWT, the main controller 140 performs the stage of a last finding signal time LFST, which is the second finding signal time, and then proceeds to the stage of the last silent time ST3.

The last finding signal time LFST is the first finding signal time when the number of finding signals is set to 1, the second finding signal time when the number of finding signals is set to 2, the third finding signal time when the number of finding signals is set to 3, the fourth finding signal time when the number of finding signals is set to 4, and the nth finding signal time when the number of finding signals is set to n. After the last finding signal is inputted, the main controller 140 proceeds to the stage of the last silent time ST3.

The last silent time ST3 is a silent time set at the stage following the last finding signal, which is longer than the second silent time ST2 set between the respective finding signals. The last silent time ST3 is set to be longer than the second silent time ST2 for the following reasons. Assume that the user uses two missing article locating apparatuses and sets the finding password of the first missing article locating apparatus to ‘1’ and the finding password of the second missing article locating apparatus to ‘2’. Provided that the last silent time ST3 is shorter than or equal to the second silent time ST2 set between the finding signals, the first missing article locating apparatus will initiate its sound output before the user inputs the second finding signal to find the second missing article locating apparatus. In order to solve this problem, the last silent time ST3 is set to be longer than the preceding second silent time ST2. Therefore, when the user inputs the second finding signal to find the second missing article locating apparatus, the first missing article locating apparatus is powered off because the signal input is present within the last silent time ST3, and the second missing article locating apparatus will initiate its sound output after delay by the last silent time ST3 following the input of the second finding signal.

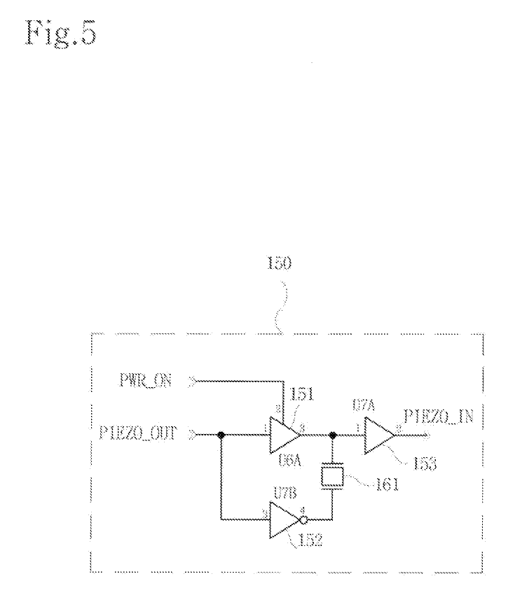

FIG. 5 is a circuit diagram of a different embodiment of the tone generator 150.

As shown in FIG. 5, a voltage for generation of an intermittent sound is supplied to an inverter 151 in response to the power-on signal PWR-ON from the main controller 140. At this time, when the intermittent sound signal PIEZO-OUT from the main controller 140 is positive, the inverter 151 outputs a negative signal and a buffer 152 outputs a positive signal, so that twice the supplied voltage is induced in the piezoelectric element 161 to oscillate the piezoelectric element 161. Similarly, when the intermittent sound signal PIEZO-OUT is negative, the inverter 151 outputs a positive signal and the buffer 152 outputs a negative signal, so that twice the supplied voltage is induced in the piezoelectric element 161 to oscillate the piezoelectric element 161. As a result, the piezoelectric element 161 functions as a buzzer by virtue of this series of operations, and as an input sensor when the power-on signal PWR-ON and the intermittent sound signal PIEZO-OUT are not applied.

In this manner, the location confirm sound (intermittent sound) is generated. After confirming the location of the finder (missing article locating apparatus) using the location confirm sound, the user can operate the function switch S1 of the function input unit 110 or input a specific sound to stop the generation of the location confirm sound. Upon recognizing the operation of the function switch S1 or the input of the specific sound, the main controller 140 controls the tone generator 150 to stop the generation of the intermittent sound and controls the indicator 120 to stop the LED operation. Here, the specific sound means a signal that the user generates by using a whistle or similar tool or by coming into contact with the missing article locating apparatus. In other words, if the function switch S1 is operated during the operation of the tone generator 150, the main controller 140 immediately controls the tone generator 150 to stop the location confirm sound generation and immediately controls the indicator 120 to stop the LED operation. Also, if the specific sound is sensed by the piezoelectric element 161 of the signal sensor 160 during the operation of the tone generator 150, namely, in a time interval between the location confirm sounds, the main controller 140 immediately controls the tone generator 150 to stop the location confirm sound generation and immediately controls the indicator 120 to stop the LED operation.

On the other hand, unless the function switch S1 is operated or the specific sound is generated during the location confirm sound generation, the intermittent sound is generated a predetermined number of times, for example, 20 times and then automatically stopped.

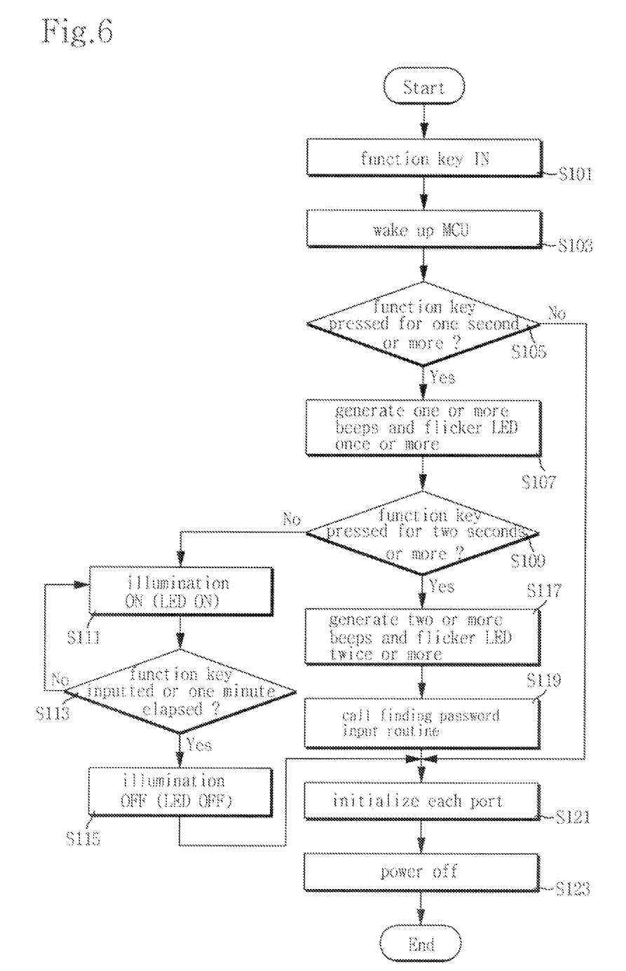

FIG. 6 is a flowchart illustrating an embodiment of an input process of the function input unit 110 according to the present invention for setting or changing a finding password in the missing article locating apparatus or using the apparatus as an illuminator.

If the function switch (function key) is pressed in an initialized state at step S101, the main controller (MCU) is woken up at step S103.

Then, the main controller determines at step S105 whether the function key has been pressed for a predetermined time or more, for example, one second or more. Upon determining that the function key has not been pressed for one second or more, the main controller recognizes the pressing of the function key as an abnormal key operation, and thus proceeds to step S121 to initialize each port and then proceeds to step S123 to turn the main power off.

Conversely, if the function key has been pressed for one second or more, the main controller recognizes the pressing of the function key as a normal key operation and proceeds to step S107 to generate one or more beeps and flicker the LED once or more, so as to inform the user that the function key has normally been operated.

Thereafter, the main controller determines at step S109 whether the function key has been pressed for a different predetermined time or more, for example, two seconds or more. In the case where the function key has not been pressed for two seconds or more, the main controller recognizes that the user uses the missing article locating apparatus as an illuminator, and proceeds to step S111 to turn the LED on so as to perform an illumination ON operation. Subsequently, the main controller proceeds to step S113 to determine whether the function key has been again inputted or whether a certain time, for example, one minute has elapsed after the LED is turned on. If the function key has not been inputted and one minute has not elapsed, the main controller maintains the current state. However, if the function key has been inputted or one minute has elapsed, the main controller proceeds to step S115 to turn the LED off so as to perform an illumination OFF operation. Then, the main controller proceeds to step S121 to initialize each port and then proceeds to step S123 to turn the main power off.

On the other hand, if it is determined at step S109 that the function key has been pressed for two seconds or more, the main controller proceeds to step S117 to generate two or more beeps and flicker the LED twice or more, so as to inform the user that he/she has to set a finding password.

Thereafter, the main controller proceeds to step S119 to call a finding password input routine to set the finding password.

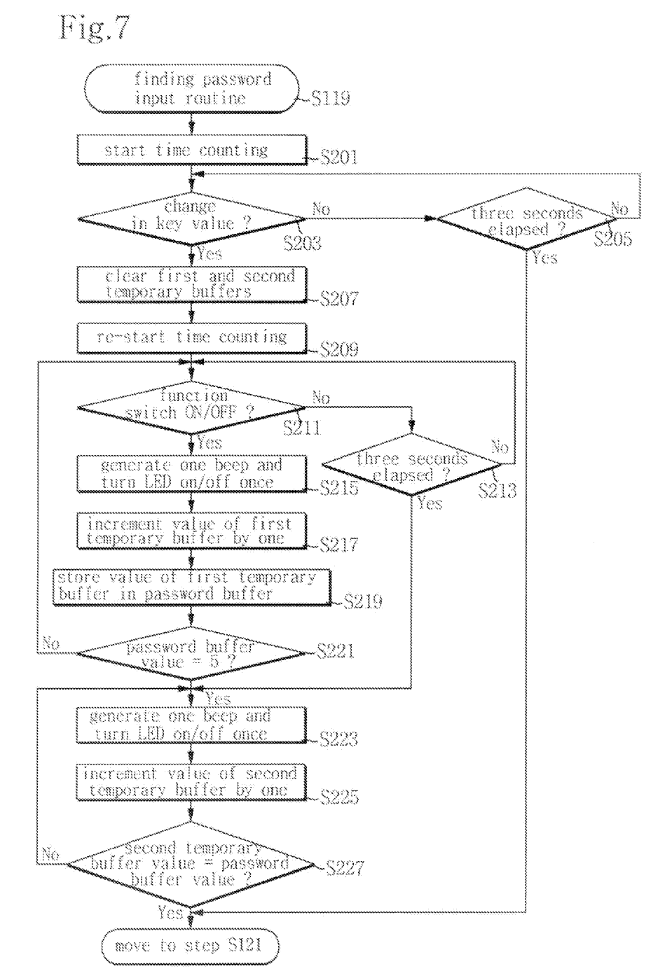

FIG. 7 is a flowchart illustrating the finding password input routine S119 in detail. At step S201, the main controller starts time counting. Then, at step S203, the main controller determines whether there is a change in key value. That is, this step S203 is a step of determining whether the function key is turned off under the condition that the finding password input routine is entered due to the initial pressing of the function key by the user for two seconds or more. If the user turns the function key off to change the finding password under this condition, the key value is changed. However, if the function key is continuously pressed in spite of the fact that the finding password input routine has been entered as two seconds or more have elapsed after the operation of the function key by the user, the main controller proceeds to step S205 to determine whether a predetermined time, for example, three seconds have elapsed. If the predetermined time has elapsed, the main controller recognizes chat the function key has not been operated by the user, but has been mis-operated by other object, ends the finding password input routine which is executed with the main power, and then proceeds to step S121 to turn the main power off so as to reduce unnecessary battery consumption. However, if the predetermined time, three seconds, have not elapsed, the main controller returns to step S203 to continue to determine whether there is a change in key value. In the case where the user turns the function key off to change the finding password in this state, the main controller proceeds to step S207 to clear first and second temporary buffers for temporarily storing the changed finding password. Thereafter, the main controller re-starts the time counting at step S209. The main controller then determines at step S211 whether the function switch has been turned on/off. If the function switch has been only turned on, not turned off, or the function switch has been turned neither on nor off, the main controller proceeds to step S213 to determine whether a predetermined time, for example, three seconds have elapsed. That is, in the case where the function switch has been only turned on, not turned off, the main controller recognizes that the function switch has been mis-operated. Also, in the case where the function switch has been turned neither on nor off, the main controller recognizes that the user intends to confirm the finding password. If the predetermined time has not elapsed, the main controller returns to step S211. Conversely, if the predetermined time has elapsed, the main controller proceeds to step S223 irrespective of the reason why the function switch has not been turned on/off at step S211. At step S223, the main controller generates one beep and turns the LED on/off once. The main controller then proceeds to step S225 to increment the value of the second temporary buffer by one. Thereafter, the main controller proceeds to step S227 to determine whether the value of the second temporary buffer is equal to the value of a password buffer. In the case where the value of the second temporary buffer is not equal to the value of the password buffer, the main controller returns to step S223 to repeat it and the subsequent steps. In the case where the value of the second temporary buffer is equal to the value of the password buffer, the main controller ends the finding password input routine and then moves to the aforementioned step S121. That is, in this case, the main controller recognizes that the user intends to confirm a pre-registered finding password, and generates the same number of beeps as the registered finding password and flickers the LED the same number of times as the registered finding password. For example, in the case where the finding password is set to 5, five beeps are generated and the LED is flickered five times.

On the other hand, if it is determined at step S211 that the function switch has been turned on/off, namely, the user has operated the function key again to change the finding password, the main controller proceeds to step S215 to generate one beep and turn the LED on/off once. Then, the main controller proceeds to step S217 to increment the value of the first temporary buffer by one and then proceeds to step S219 to store the value of the first temporary buffer in the password buffer. Thereafter, the main controller proceeds to step S221 to determine whether the value of the password buffer is 5 (where the missing article locating apparatus is designed such that the finding password can be changed to up to 5). Upon determining that the value of the password buffer is not 5, the main controller returns to the aforementioned step S211. Subsequently, the main controller again determines at step S211 whether the function switch has been turned on/off, and proceeds to step S213 or step S215 according to the determination result. Here, in the case where the user changes the finding password to ‘1’, the function switch is not turned on/off. As a result, the main controller moves to step S223 after three seconds elapse. However, in the case where the user changes the finding password to ‘2’ or more, the function switch is turned on/off. As a result, the main controller moves to step S215.

After the finding password is newly set in the above manner, the main controller repeats steps S223 to S227 the same number of times as the newly set finding password and then proceeds to step S121.

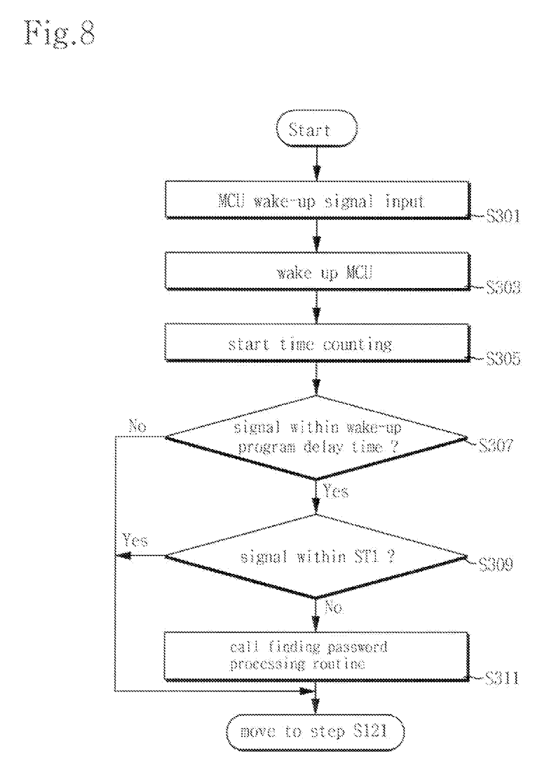

Under the condition that the finding password is set as stated above, a missing article locating method according to the present invention is performed through a process as shown in FIG. 8.

FIG. 8 is a flowchart illustrating an embodiment of a wake-up signal processing process of the missing article locating method according to the present invention.

When a wake-up signal for the main controller which lasts for at least the wake-up hardware delay time WHDT set by the circuit configuration is inputted at step S301, the main controller is woken up at step S303. Then, the main controller starts time counting at step S305.

The main controller then determines at step S307 whether the inputted wake-up signal lasts for the wake-up program delay time WPDT of the wake-up signal time WST obtained by excluding the wake-up hardware delay time WHDT from the wake-up signal time WST. In the case where the inputted wake-up signal does not last within the wake-up program delay time WPDT, the main controller proceeds to the aforementioned step S121. Conversely, in the case where the inputted wake-up signal lasts for the wake-up program delay time WPDT, the main controller recognizes that the inputted wake-up signal is normal, and then proceeds to step S309 to determine whether a signal is present within the first silent time ST1. Upon determining that a signal is present within the first silent time ST1, the main controller regards the signal as noise and then moves to step S121. However, in the case where no signal is present within the first silent time ST1, the main controller proceeds to step S311 to call a finding password processing routine to process a finding password.

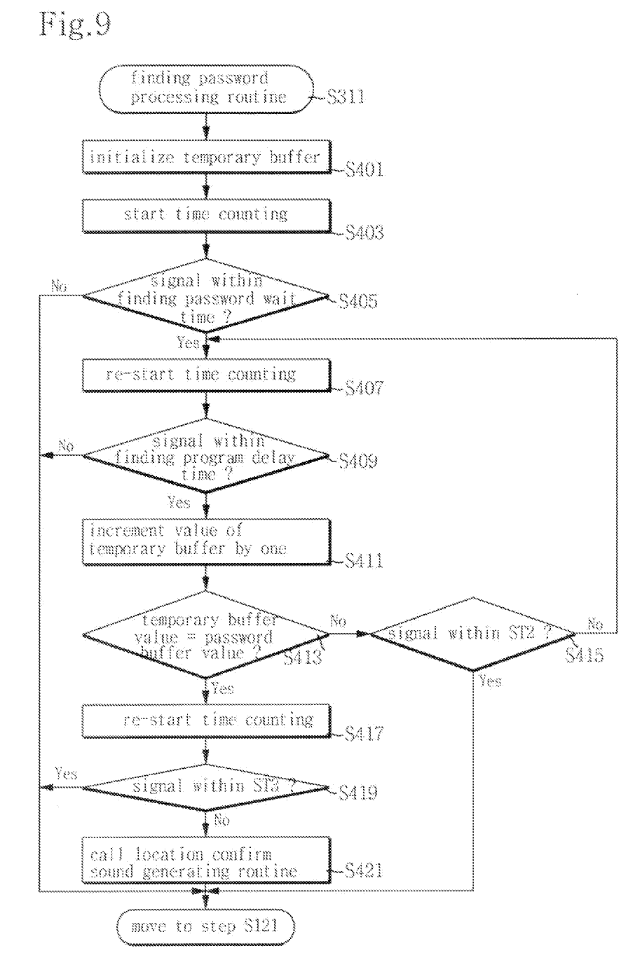

FIG. 9 is a flowchart illustrating an embodiment of the finding password processing routine S311.

The main controller initializes a temporary buffer at step S401 and starts time counting at step S403.

Then, the main controller determines at step S405 whether an input signal is present within the finding password wait time FWT. If no input signal is present within the finding password wait time FWT, the main controller ends the finding password processing routine and then moves to step S121. However, in the case where an input signal is present within the finding password wait time FWT, the main controller proceeds to step S407 to re-start the time counting. At this time, the finding hardware delay time FHDT is present, which is not shown in FIG. 9 although shown in the timing diagram for password recognition of FIG. 4. The finding hardware delay time FHDT is a delay time which is generated by the integrator 171 and signal delay 172 shown in FIG. 1 whenever each finding signal is inputted. This finding hardware delay time FHDT is not shown in FIG. 9 because it is present on only the circuit and is not recognized by the program. Therefore, when a product is designed, the finding password wait time FWT at step S405 and the finding program delay time FPDT at step S409 must be determined in consideration of the finding hardware delay time FHDT essentially existing therebetween.

Thereafter, the main controller determines at step S409 whether the input signal lasts for the finding program delay time FPDT. In the case where the input signal does not last within the finding program delay time FPDT, the main controller regards the input signal as noise, ends the finding password processing routine, and then proceeds to step S121. Conversely, in the case where the input signal lasts for the finding program delay time FPDT, the main controller recognizes that the input signal is a normal finding signal. As a result, the main controller proceeds to step S411 to increment the value of the temporary buffer by one, and then determines at step S413 whether the value of the temporary buffer is equal to the value of the password buffer. Upon determining that the value of the temporary buffer is not equal to the value of the password buffer, the main controller recognizes that the finding password is not 1, and then moves to step S415 to determine whether a signal is present within the second silent time ST2. If it is determined that a signal is present within the second silent time ST2, the main controller regards the signal as noise and then moves to step S121. However, in the case where no signal is present within the second silent time ST2, the main controller returns to step S407 to repeat it and the subsequent steps. In the case where the value of the temporary buffer is equal to the value of the password buffer, the main controller recognizes that the value of the temporary buffer is the same as the finding password, and then proceeds to step S417 to re-start the time counting. Thereafter, the main controller determines at step S419 whether a signal is present within the last silent time ST3, so as to confirm the end of the finding password. If it is determined that a signal is present within the last silent time ST3, the main controller regards the signal as noise, ends the finding password processing routine, and then moves to step S121. In the case where no signal is present within the last silent time ST3, the main controller recognizes that the finding password is normal, and then proceeds to step S421 to call a location confirm sound generating routine.

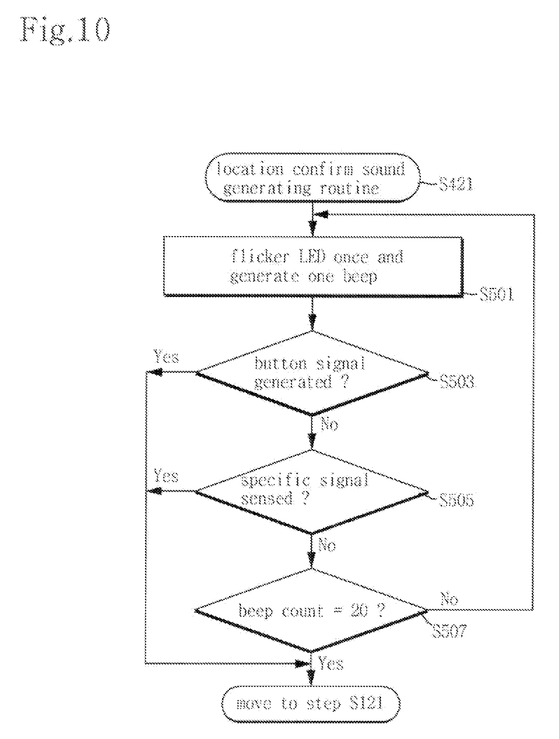

FIG. 10 is a flowchart illustrating an embodiment of the location confirm sound generating routine.

At step S501, the main controller flickers the LED once and generates one beep. At this time, the once-flickering of the LED and the generation of the one beep mean that one beep is generated at the same time that the LED is flickered once, that two beeps are temporally successively generated at the same time that the LED is flickered temporally successively twice, or that three beeps are temporally successively generated at the same time that the LED is flickered temporally successively three times. Thereafter, the main controller determines at step S503 whether a button signal (a signal generated when the function switch is operated by the user) has been generated. If a button signal has been generated, the main controller moves to step S121 to initialize each port and turn the main power off. Conversely, in the case where no button signal has been generated, the main controller proceeds to step S505 to determine whether a specific signal has been sensed. Here, the specific signal means a wave-shaped signal that the user remotely generates by using a whistle or similar tool or a sound signal that the user generates by coming into contact with the missing article locating apparatus, in order to stop the location confirm sound in the middle of the generation of the location confirm sound by the missing article locating apparatus. This specific signal is generated for the purpose of stopping the location confirm sound in the middle of the generation of the location confirm sound even by using a whistle or coming into contact with the missing article locating apparatus, without operating the function switch.

If a specific signal has been sensed, the main controller moves to step S121 to initialize each port and turn the main power off. However, in the case where no specific signal has been sensed, the main controller proceeds to step S507 to determine whether a beep count has reached a specific value, for example, 20. If the beep count has not reached 20, the main controller returns to step S501 to repeat it and the subsequent steps. Conversely, in the case where the beep count has reached 20, the main controller moves to step S121 to initialize each port and turn the main power off. Here, the beep count is a value which is counted to automatically stop the generation of the location confirm sound, and the specific value means the number of times that the LED is flickered and the number of beeps that are generated. The specific value is not limited to 20, but can be increased or reduced according to a designer's intention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for locating a missing article, comprising:
a signal sensor for sensing a wave-shaped signal generated by a user;
a signal processor for interrupting an input of the wave-shaped signal sensed by the signal sensor when the sensed signal is maintained for less than a predetermined time, and compulsorily interrupting an output of the sensed signal when the sensed signal is maintained for more than the predetermined time; and
a main controller for comparing an output signal from the signal processor with a password stored in a memory, and outputting control signals for generation of visual and audible location confirm signals when the output signal from the signal processor is the same as the stored password.

2. The apparatus according to claim 1, further comprising:
an indicator for generating the visual location confirm signal in response to a corresponding one of the control signals from the main controller; and
a tone generator for generating the audible location confirm signal in response to a corresponding one of the control signals from the main controller.

3. The apparatus according to claim 1, wherein the wave-shaped signal includes any one of a wake-up signal which is a long-period signal of a certain length and a finding signal which is a long-period signal of the certain length or a relatively short-period signal, each of the long-period signals having a duration of 0.1 or 0.2 seconds or more, the short-period signal having a duration shorter than the duration of each of the long-period signals,
wherein silent times and finding password wait times are set respectively between the wake-up signal and the finding signal, between respective finding signals including the finding signal when the number of the finding signals is set to two or more, and after a last one of the finding signals.

4. The apparatus according to claim 3, wherein the number of wake-up signals including the wake-up signal is fixed at ‘1’ by a program and the number of the finding signals is set or changed according to a period of time and the number of times that a function switch is pressed by the user.

5. The apparatus according to claim 3, wherein the main controller determines the wake-up signal to be valid when the wake-up signal passes a wake-up hardware delay time, wakes up the main controller and lasts up to a wake-up program delay time determined by a program of the main controller.

6. The apparatus according to claim 5, wherein the main controller turns off main power of the apparatus when the wake-up signal does not last within the wake-up hardware delay time, when it passes the wake-up hardware delay time, but does not last within the wake-up program delay time, or when it lasts for more than the wake-up program delay time.

7. The apparatus according to claim 3, wherein the silent times include a first silent time set between the wake-up signal and the finding signal,
wherein the main controller proceeds to a stage of a first one of the finding password wait times when no external signal is inputted within the first silent time.

8. The apparatus according to claim 7, wherein the main controller turns off main power of the apparatus when an external signal is inputted within the first silent time.

9. The apparatus according to claim 3, wherein the finding password wait times include a first finding password wait time set after a first one of the silent times following the wake-up signal,
wherein the main controller determines the finding signal to be valid when the finding signal is inputted for the first finding password wait time, passes a finding hardware delay time determined by a circuit configuration and lasts up to a finding program delay time determined by a program of the main controller.

10. The apparatus according to claim 9, wherein the main controller turns off main power of the apparatus when the finding signal is not inputted within the first finding password wait time.

11. The apparatus according to claim 9, wherein the main controller turns off main power of the apparatus when the finding signal does not last within the finding hardware delay time, when it passes the finding hardware delay time, but does not last within the finding program delay time, or when it lasts for more than the finding program delay time.

12. The apparatus according to claim 9, wherein the silent times include a last silent time set after the last finding signal.

13. The apparatus according to claim 12, wherein the main controller generates the location confirm signals when no signal is inputted within the last silent time, and turns off main power of the apparatus when a signal is inputted within the last silent time.

14. The apparatus according to claim 13, wherein the last silent time is set to be longer than the respective silent times set between the respective finding signals.

15. An apparatus for locating a missing article, comprising:
a signal sensor including a piezoelectric element for detecting an external signal and generating a location confirm sound, a signal buffer for buffering the signal detected by the piezoelectric element, and an analog/digital converter for converting an analog signal from the signal buffer to a digital signal;
a signal processor including an integrator for integrating a signal sensed by the signal sensor, a signal delay for delaying an output signal from the integrator, an inverter for interrupting an output signal from the signal delay when it is inputted for less than a predetermined time and inverting a phase of the output signal from the signal delay when it is inputted for the predetermined time or more, and a compulsory signal interrupter for compulsorily interrupting an output signal from the inverter when the output signal from the inverter lasts for more than the predetermined time; and
a main controller including a memory for storing a password, and a plurality of timers for counting respective periods of a wake-up signal and one or more finding signals, silent times, and one or more finding password wait times, respectively.

16. The apparatus according to claim 15, wherein the signal buffer comprises:
a band pass filter for band pass filtering the signal detected by the piezoelectric element;
a primary amplifier for primarily amplifying an output signal from the band pass filter; and
a secondary amplifier for adjusting sensitivity of the signal primarily amplified by the primary amplifier and secondarily amplifying the resulting signal.

17. The apparatus according to claim 15, wherein the signal processor removes noise and outputs only a wave-shaped signal, using time constants of resistors and capacitors constituting the integrator and signal delay.

18. The apparatus according to claim 15, further comprising a tone generator including:
a first transistor turned on in response to a power-on signal from the main controller for supplying a voltage for generation of an intermittent sound to a driving coil; and
a second transistor turned on in response to an intermittent sound signal from the main controller for generating counter-electromotive current through the driving coil,
wherein the piezoelectric element generates the intermittent sound as the location confirm sound in response to the counter-electromotive current, and functions as an input sensor when the power-on signal and the intermittent sound signal are not applied,
wherein the main controller automatically stops the generation of the location confirm sound by the piezoelectric element when the piezoelectric element detects an external signal in the middle of generating the location confirm sound.

19. The apparatus according to claim 15, further comprising a tone generator including:
a second inverter for receiving a voltage for generation of an intermittent sound in response to a power-on signal from the main controller and inverting a phase of an intermittent sound signal from the main controller;
a buffer for applying, to the piezoelectric element, a voltage which is 180° out of phase with an output voltage from the second inverter,
wherein the piezoelectric element generates the intermittent sound as the location confirm sound in response to the voltage applied from the buffer, and functions as an input sensor when the power-on signal and the intermittent sound signal are not applied,
wherein the main controller automatically stops the generation of the location confirm sound by the piezoelectric element when the piezoelectric element detects an external signal in the middle of generating the location confirm sound.

20. A method for locating a missing article using a missing article locating apparatus, comprising:
a) if an input signal lasts for a wake-up hardware delay time determined by a circuit configuration of the missing article locating apparatus in a standby mode where standby power is supplied to the apparatus, calling a wake-up password processing routine and supplying main power to the apparatus, and if the input signal further lasts for a wake-up program delay time, determining the input signal to be a valid wake-up signal, determining whether a signal is inputted for a first silent time, and starting time counting for confirmation of a finding signal if no signal is inputted for the first silent time;
b) calling a finding password processing routine if the finding signal is inputted at a predetermined timing during the time counting at the step a), determining whether a signal is inputted for a second silent time if a pre-registered finding password is set to two or more, and determining whether the pre-registered finding password is satisfied if no signal is inputted for the second silent time; and
c) determining whether a signal is inputted for a last silent time if the pre-registered finding password is satisfied, calling a location confirm sound generating routine to generate a location confirm sound, if no signal is inputted for the last silent time, and stopping the generation of the location confirm sound if a signal is sensed in the middle of generating the location confirm sound, a signal is inputted through a function input unit, or the number of times that the location confirm sound is generated expires.

21. The method according to claim 20, wherein the wake-up password processing routine comprises:
a-1) if a wake-up signal for a main controller which lasts for at least the wake-up hardware delay time set by the circuit configuration is inputted, waking up the main controller and starting the time counting;
a-2) determining whether the inputted wake-up signal lasts for the wake-up program delay time after the step a-1) and ending the wake-up password processing routine if the inputted wake-up signal does not last within the wake-up program delay time;
a-3) recognizing that the inputted wake-up signal is normal if the inputted wake-up signal lasts for the wake-up program delay time;
a-4) determining whether a signal is present within the first silent time after the step a-3), and if a signal is present within the first silent time, regarding the signal as noise and ending the wake-up password processing routine; and
a-5) if no signal is present within the first silent time, determining that the wake-up password processing routine has been normally executed and calling the finding password processing routine.

22. The method according to claim 20, wherein the finding password processing routine comprises:
b-1) initializing a temporary buffer which temporarily stores an inputted finding password and starting the time counting;
b-2) determining whether an input signal is present within a finding password wait time, and ending the finding password processing routine if no input signal is present within the finding password wait time;
b-3) if an input signal is present within the finding password wait time, re-starting the time counting and determining whether the input signal lasts for a finding signal time, and if the input signal does not last within the finding signal time, regarding the input signal as noise and ending the finding password processing routine, and if the input signal lasts for the finding signal time, recognizing that the input signal is a normal finding signal;
b-4) incrementing a value of the temporary buffer by one, determining whether the value of the temporary buffer is equal to a value of a password buffer, and determining whether a signal, is present within the second silent time if the value of the temporary buffer is not equal to the value of the password buffer;
b-5) if it is determined at the step b-4) that a signal is present within the second silent time, regarding the signal as noise and ending the finding password processing routine;
b-6) if it is determined at the step b-4) that no signal is present within the second silent time, re-starting the time counting and repeating the steps b-3) and b-4), and if it is determined at the step b-4) that the value of the temporary buffer is equal to the value of the password buffer, re-starting the time counting; and
b-7) determining whether a signal is present within the last silent time, so as to confirm an end of the inputted finding password, and if a signal is present within the last silent time, regarding the signal as noise and ending the finding password processing routine, and if no signal is present within the last silent time, recognizing that the inputted finding password is normal and calling the location confirm sound generating routine.

23. The method according to claim 20, wherein the location confirm sound generating routine comprises:
c-1) flickering a light emitting diode once and generating one beep;
c-2) determining whether a button signal has been generated by an operation of a function switch of the function input unit by a user and ending the generation of the location confirm sound if the button signal has been generated;
c-3) determining whether a specific signal has been sensed if no button signal has been generated, and ending the generation of the location confirm sound if the specific signal has been sensed, and
c-4) if no button signal has been generated and no specific signal has been sensed, generating the location confirm sound the same number of times as a predetermined beep count and then automatically ending the generation of the location confirm sound.

24. An input method of a function input unit of a missing article locating apparatus, comprising:
a) if a function key of the function input unit is operated in a standby mode where standby power is supplied to the missing article locating apparatus, supplying main power to the apparatus and determining whether the function key has been pressed for a predetermined first time or more, and if it is determined that the function key has not been pressed for the first time or more, recognizing the pressing of the function key as an abnormal key operation, initializing each port and then turning the main power off;
b) if the function key has been pressed for the first time or more, recognizing the pressing of the function key as a normal key operation, generating a beep and flickering a light emitting diode, so as to inform a user that the function key has normally been operated;
c) determining whether the function key has been pressed for a predetermined second time or more after the step b), and if it is determined that the function key has not been pressed for the second time or more, recognizing that the user uses the missing article locating apparatus as an illuminator and turning the light emitting diode on to perform an illumination function;
d) if the function key is again inputted or a certain time elapses after the light emitting diode is turned on, turning the light emitting diode off to end the illumination function, initializing each port and then turning the main power off; and
e) if it is determined at the step c) that the function key has been pressed for the second time or more, generating the beep and flickering the light emitting diode, so as to inform the user that he/she has to set a finding password, and calling a finding password input routine to set the finding password.

25. The input method according to claim 24, wherein the finding password input routine comprises:
e-1) starting time counting, determining whether there is a change in a value of the function key, determining whether a predetermined time has elapsed if there is no change in the function key value, and if the predetermined time has elapsed, recognizing the pressing of the function key as an abnormal key operation, initializing each port and then turning the main power off;
e-2) if it is determined at the step e-1) that there is a change in the function key value, initializing first and second temporary buffers for temporarily storing a changed finding password, and re-starting the time counting;
e-3) determining whether the function key has been turned on/off, determining whether the predetermined time has elapsed if the function switch has been only turned on, not turned off, or the function switch has been turned neither on nor off, and if the predetermined time has elapsed, recognizing that the user intends to confirm a registered finding password, generating the same number of beeps as the registered finding password and flickering the light emitting diode the same number of times as the registered finding password;
e-4) if it is determined at the step e-3) that the function switch has been turned on/off, informing, through the beep and light emitting diode, the user that a new finding password has been inputted, incrementing a value of the first temporary buffer by a predetermined value and storing the value of the first temporary buffer in a password buffer;
e-5) selectively repeating the step e-3) or e-4) if the value stored in the password buffer is not a changeable maximum value; and
e-6) after the step e-5), generating the same number of beeps as a newly registered finding password and flickering the light emitting diode the same number of times as the newly registered finding password, so as to inform the user of the newly registered finding password.
